(19) United States
(12) Patent Application Publication
(10) Pub. No.: US 2012/0317027 A1
(43) Pub. Date: Dec. 13, 2012

(54) Computer-Implemented Systems And Methods For Real-Time Scoring Of Enterprise Data

(76) Inventors: Ho Ming Luk, San Diego, CA (US); Daniel J. Dotson, Poway, CA (US); Paul C. Dulany, San Diego, CA (US); Revathi Subramanian, San Diego, CA (US); Brian Lee Duke, Poway, CA (US); Vijay S. Desai, San Diego, CA (US)

(21) Appl. No.: 13/158,999

(22) Filed: Jun. 13, 2011

(51) Int. Cl. G06Q 40/00; G06F 15/18; G06N 5/02

(52) U.S. Cl. 705/44; 706/46; 706/47; 706/12

(57) ABSTRACT

Systems and methods are provided for providing real-time scoring of received transaction data. Transaction data describing a particular transaction that has occurred is received. The transaction data is stored in an enterprise database, where the enterprise database is configured to store transactions of disparate types, where the transaction data is stored using a plurality of segments, where a segment is formatted according to a template, and where the template is selected based on an attribute of the transaction, wherein the attribute is a customer attribute, an activity attribute, or a channel attribute. A transaction type of the particular transaction is determined. One or more models are selected from a pool of models based on the transaction type, wherein the one or more models are configured based on a plurality of records from the enterprise database, and a score of the received transaction data is generated based on the transaction data.

### TECHNICAL FIELD

This document relates generally to computer predictive models and more particularly to enterprise data handling and scoring.

### BACKGROUND

Computer predictive models have been used for many years in a diverse number of areas, such as in the financial industry. For example, the computer predictive models provide an automated or semi-automated mechanism for determining whether suspicious activity, such as credit card fraud, may have occurred. However, current systems may be limited in the data that they are provided for performing such analyses.

### SUMMARY

In accordance with the teachings provided herein, systems and methods are provided for storing transaction data associated with transactions of disparate types. Transaction data is received describing a transaction that has occurred, the transaction being performed by an customer of a particular customer type, the transaction being of a particular activity type, and the transaction being performed using a channel of a particular channel type. Transaction data about the customer is stored in a customer segment according to one of a plurality of customer templates, the one of the plurality of customer templates being selected according to the customer type. Transaction data about the activity is stored in an activity segment according to one of a plurality of activity templates, the one of the plurality of activity templates being selected according to the activity type. Transaction data about the channel is stored in a channel segment according to one of a plurality of channel templates, the one of the plurality of channel templates being selected according to the channel type. Data from the customer segment, the activity segment, and the channel segment for the transaction is extracted and scored by a predictive model.

As another example, a system for storing transaction data associated with transactions of disparate types is provided. The system may include one or more data processors and a computer-readable medium encoded with instructions for commanding the one or more data processors to execute steps. In the steps, transaction data is received describing a transaction that has occurred, the transaction being performed by an customer of a particular customer type, the transaction being of a particular activity type, and the transaction being performed using a channel of a particular channel type. Transaction data about the customer is stored in a customer segment according to one of a plurality of customer templates, the one of the plurality of customer templates being selected according to the customer type. Transaction data about the activity is stored in an activity segment according to one of a plurality of activity templates, the one of the plurality of activity templates being selected according to the activity type. Transaction data about the channel is stored in a channel segment according to one of a plurality of channel templates, the one of the plurality of channel templates being selected according to the channel type. Data from the customer segment, the activity segment, and the channel segment for the transaction is extracted and scored by a predictive model.

As a further example, a computer-readable medium may be configured to store transaction data associated with transactions of disparate types, the transaction data describing a transaction that has occurred, the transaction being performed by a customer of a particular customer type, the transaction being of a particular activity type, and the transaction being performed using a channel of a particular channel type. The computer-readable medium may include a customer segment on the computer-readable medium formatted according to one of a plurality of customer templates, the one of the plurality of customer templates being selected for the customer segment according to the customer type. The computer-readable medium may further include an activity segment on the computer-readable medium formatted according to one of a plurality of activity templates, the one of the plurality of activity templates being selected according to the activity type, and a channel segment on the computer-readable medium formatted according to one of a plurality of channel templates, the one of the plurality of channel templates being selected according to the channel type. The computer-readable medium may be configured to provide data associated with the transaction from the customer segment, the activity segment, and the channel segment to a predictive model for scoring.

### BRIEF DESCRIPTION OF THE FIGURES

FIG. 1 is a block diagram depicting a computer-implemented system managing enterprise data.

FIG. 2 is a block diagram depicting certain systems for individually storing and scoring data of disparate transaction types.

FIG. 3 is a block diagram depicting an enterprise data management system.

FIG. 4 is a block diagram depicting data storage using an example enterprise data management system.

FIG. 5 depicts example attributes for different transaction segments.

FIG. 6 is a block diagram depicting an example enterprise data management system.

FIG. 7 is a block diagram depicting segment template selection.

FIGS. 8A and 8B depict example templates for segment storage.

FIG. 9 is a diagram depicting an example visualization for describing one form of storage that may be used by an enterprise data management system.

FIG. 10 depicts an example construction of a transaction message cargo train.

FIG. 11 is a block diagram depicting processing of bank transactions using an enterprise data management system.

FIG. 12 is a block diagram depicting example scoring of transaction data representative of transactions of disparate types.

FIG. 13 is a block diagram depicting example real-time scoring of received transaction data.

FIG. 14 is a block diagram depicting example aggregate data and real-time scoring of received transaction data.

FIG. 15 is block diagram depicting model selection for real-time scoring of transaction data.

FIG. 16 is a block diagram depicting generation of a real-time transaction score.

FIG. 17 is a block diagram depicting deployment of multiple scoring models to support decisioning on various aspects of different banking products.

FIGS. 18A, 18B, and 18C depict example systems for use in implementing an enterprise data management system.

### DETAILED DESCRIPTION

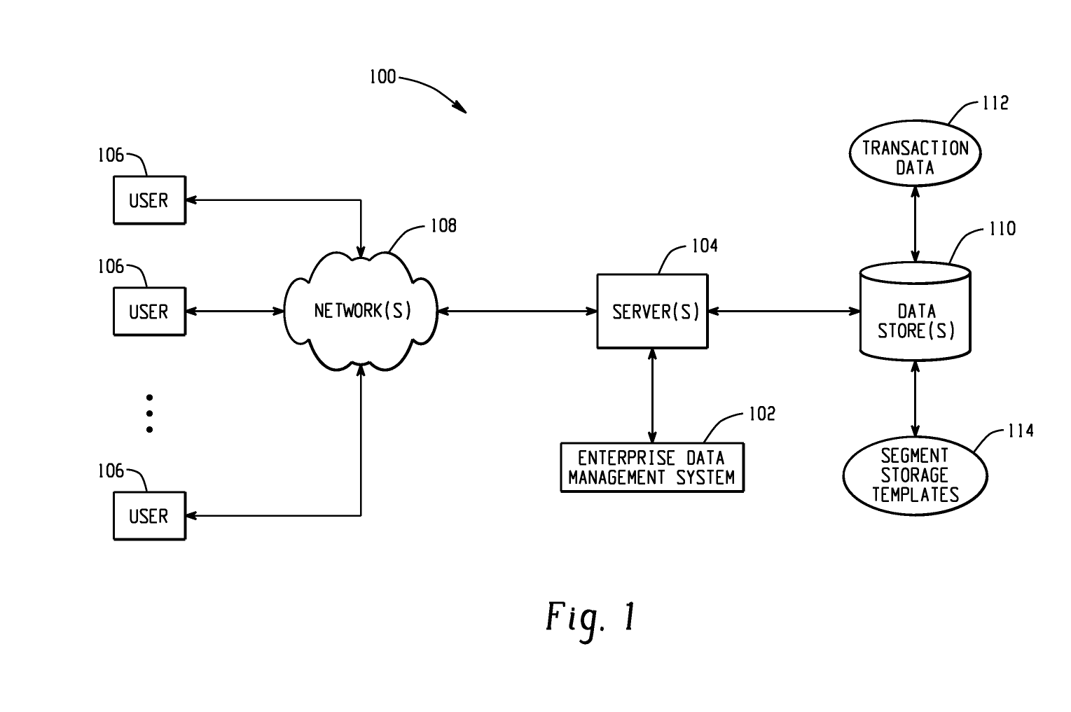

FIG. 1 is a block diagram depicting a computer-implemented system managing enterprise data. FIG. 1 depicts a computer-implemented enterprise data management system 102 for handling and scoring enterprise data. The enterprise data management system 102 provides a platform for processing received data associated with transactions of disparate types, managing storage of that received data, and making stored data available for scoring.

For example, an enterprise data management system 102 may be utilized in a banking system. Banks have traditionally gathered and analyzed large amounts of data related to customer actions. For example, a bank may track a history of a particular customer's credit card usage. Based on the tracked history, the bank may identify certain parameters that are consistent with the particular customer's credit card usage. For example, the bank may identify a transaction volume parameter, a transaction location parameter, a transaction amount parameter, an on-time balance payment parameter, and a balance amount parameter. These identified parameters may then be used by a predictive model to help score various aspects of a new credit card transaction received for the particular customer.

For example, the transaction volume, transaction location, and transaction amount parameters may be used by a predictive model to identify the likelihood that one or more newly received credit card transactions from a customer are fraudulent. A new transaction may be identified as likely fraudulent for a number of reasons. For example, if a higher than normal volume of transactions for the particular customer are received from a remote country, far from the customer's regular transaction locations, one or more transactions may be identified as likely fraudulent and flagged for further investigation.

As another example, the transaction volume, transaction amount, on-time balance payment parameter, and balance amount parameter may be used to score a new transaction to determine whether the new transaction should be authorized from a credit risk perspective. For example, if a newly received transaction is for a higher than usual transaction amount, and the particular customer has a higher than usual balance amount, then the bank may wish to decline to transaction for being too risky. However, if the particular customer has a high on-time balance payment parameter, a higher amount of trust may be afforded to the particular customer by the bank, and the credit card transaction may be approved despite being out of the bounds of certain parameters for the particular customer.

Scoring a set of transactions of a particular type may be highly useful for analyzing certain aspects of those transactions. However, an additional level of synergy may be achieved by analyzing a number of transactions of disparate types. For example, fraud being perpetrated against a particular customer who has had his identity stolen may be better identified by looking at all transactions associated with the particular customer rather than transactions of single types in isolation. A fraudster may make small or otherwise difficult to distinguish transactions purporting to be the particular customer using various channels. For example, the fraudster may purchase gasoline using a falsified credit card, pay a dinner bill using a false debit card, and purchase concert tickets using a bad check using the particular customer's account. None of these transactions on their own may be of a sufficient suspicious nature to be flagged as likely fraudulent. Additionally, because the transactions are all of disparate types (i.e., credit card, debit card, check), no aggregation within one of the transaction types will aid a predictive model in identifying the fraud. However, if all three of the transactions of disparate types are analyzed together, a predictive model may be able to identify that these transactions are likely fraudulent (e.g., the credit card gasoline purchase by the fraudster was made at a city 25 miles away from a location of a legitimate point of sale debit card purchase by the particular customer with the transactions occurring 3 minutes apart).

Traditional systems are unable to offer such analyses because those systems do not use and store data from disparate transaction types together. For example, a bank will typically have a credit card data store, a debit card data store, a checking account data store, a mortgage account data store, as well as others. Each of these types of transactions is typically analyzed for fraud completely separately. No data is typically shared between systems serving various account types within a bank. Predictive models may be run to analyze data stored in those individual data stores in isolation. One reason for this isolated approach is the data disparity among transactions of disparate types. For example, a record of a credit card purchase may track a credit card number and an expiration date of the credit card used to make the purchase, while a check purchase record may track a routing number and account number associated with a check used to make the purchase. Because it would be highly impractical to store data records containing all fields needed for tracking all possible transaction types, the isolated transaction type data stores have been utilized.

While the above example describes transactions that are of different type based on differing transaction account types (e.g., credit card, debit card, check), transactions can be of disparate types based on variations in other aspects as well. For example, transactions may be of disparate types based on customer type (e.g., business, individual), channels (e.g., point-of-sale, online, mobile phone), authentication type, or activity (e.g., purchase, bill pay, funds transfer).

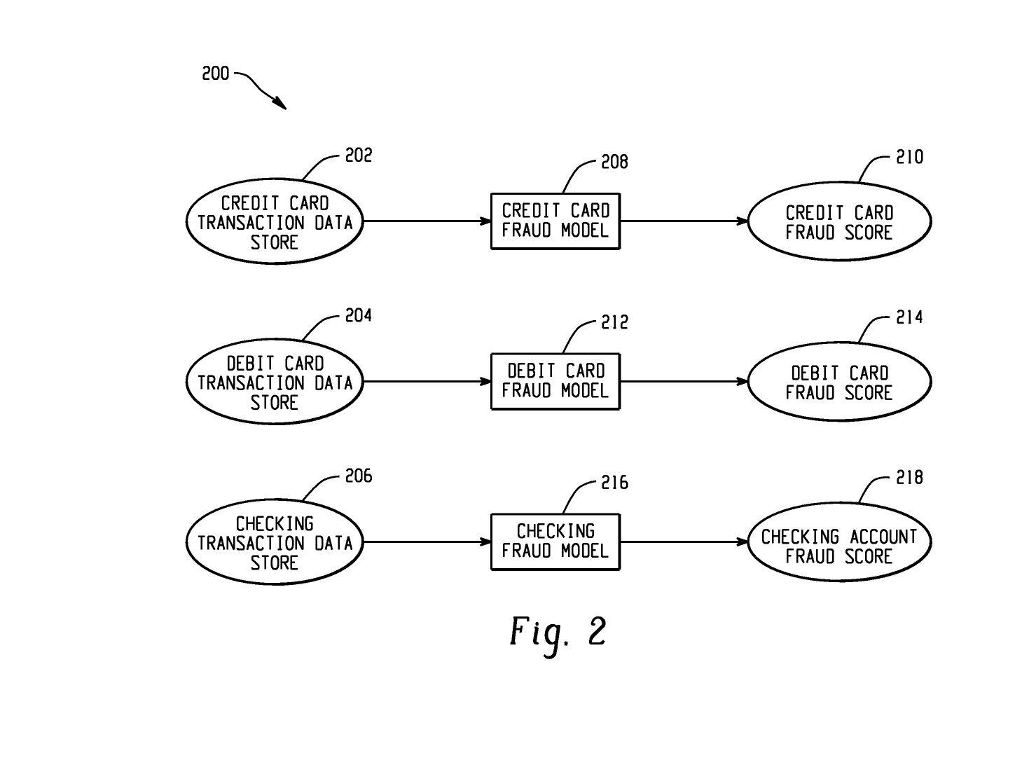

FIG. 2 is a block diagram depicting certain systems for individually storing and scoring data of disparate transaction types. Each of the disparate transaction types is stored in an individual data store (e.g., a credit card transaction data store 202, a debit card transaction data store 204, and a checking transaction data store 206). Data from each of the individual data stores 202, 204, 206 is scored by a particular model for that transaction type. For example, a credit card fraud model 208 scores data from the credit card transaction data store 202 to generate a credit card fraud score 210. Similarly, a debit card fraud model 212 scores data from the debit card transaction data store 204 to generate a debit card fraud score 214. As another example, a checking fraud model 216 scores data from the checking transaction data store 206 to generate a checking account fraud score 218.

With reference back to FIG. 1, an enterprise data management system 102 provides systems and methods for storing transaction data associated with transactions of disparate types, where the enterprise data management system 102 can be configured to provide data associated with transactions to one or more predictive models for scoring. The enterprise data management system 102 may be provided using one or more servers 104. One or more users 106 interact with an enterprise data management system 102 via one or more networks 108. The enterprise data management system 102 may be responsive to one or more data stores 110. The one or more data stores 110 may contain a variety of data associated with the enterprise data management system 102, such as transaction data 112 and segment storage templates 114 used for storing transaction data 112 of disparate types, as will be described in further detail herein.

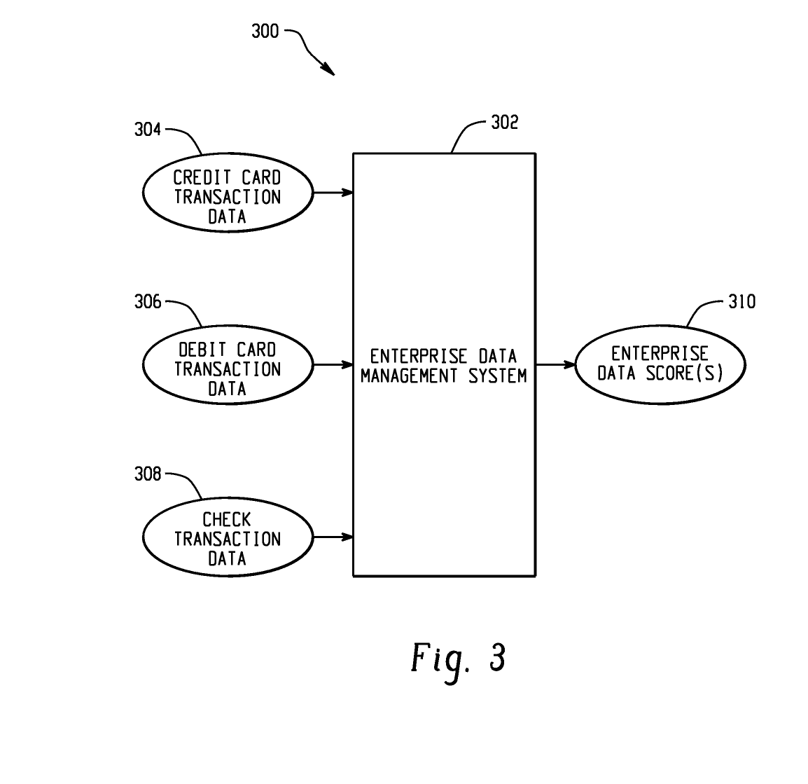

FIG. 3 is a block diagram depicting an enterprise data management system. The enterprise data management system 302 receives transaction data associated with transactions of disparate types. For example, the enterprise data management system 302 may receive credit card transaction data 304, debit card transaction data 306, check transaction data 308, as well as other types of transaction data. The enterprise data management system 302 may coordinate storage of the received transaction data 304, 306, 308 and may also facilitate scoring of that data. For example, data associated with transactions of multiple of the different transaction types may be considered in generating one or more enterprise data scores 310.

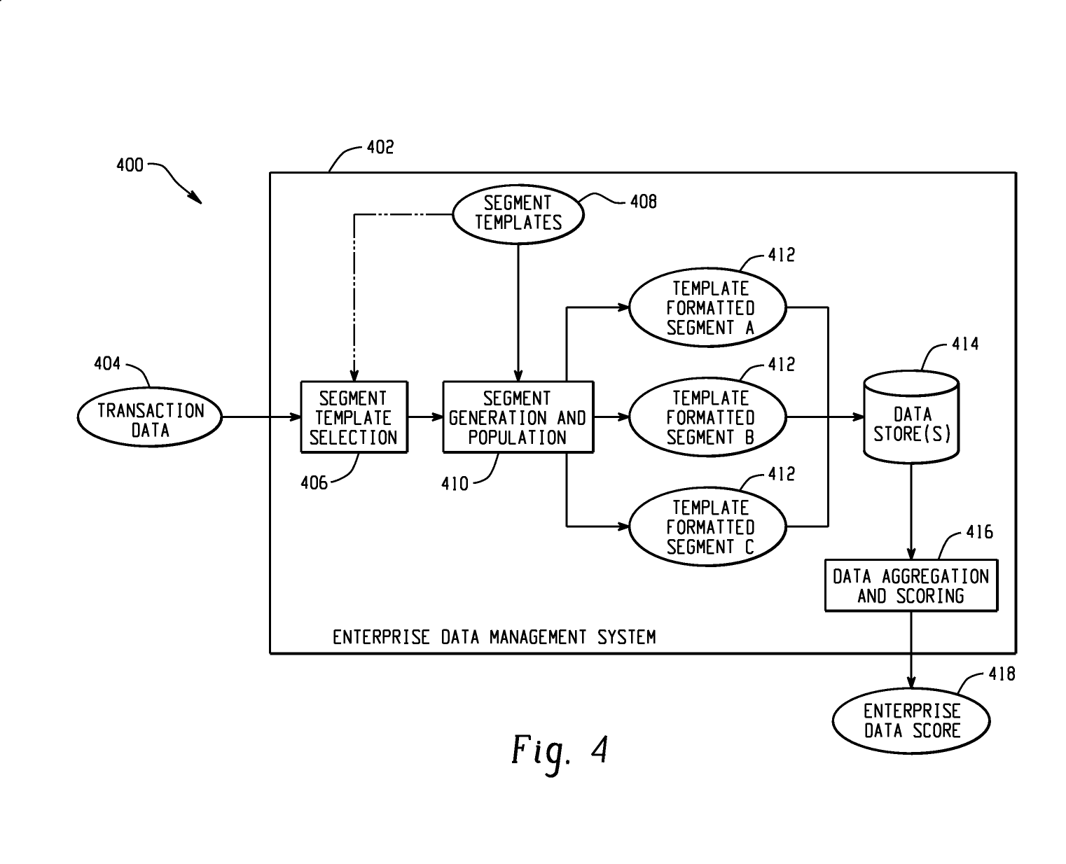

FIG. 4 is a block diagram depicting data storage using an example enterprise data management system. The enterprise data management system 402 uses a flexible storage interface to enable storage of transaction data representing transactions of disparate types in a common data store. By storing the transaction data in a common data store, the data spanning different transaction types may be analyzed together, enabling better identification of trends, patterns, and other indicators of interest in scoring data. The enterprise data management system 402 receives transaction data 404. The transaction data 404 describes a transaction that has occurred. For example, the transaction may have been performed by a customer of a particular customer type, the transaction may be of a particular activity type, and the transaction may have been performed using a channel of a particular channel type (e.g., an individual pays a bill using their online banking account).

At 406, segment template selection is performed for the received transaction data 404. The enterprise data management system 402 maintains one or more segment templates 408 for each of a plurality of different segments. For example, for a customer segment, the enterprise data management system 402 may maintain an individual customer template and a business customer template. As another example, for a channel segment, the enterprise data management system 402 may maintain a point of sale template, an online template, and a mobile device template. Based on the attributes associated with a transaction (e.g., customer type, activity type, channel type), a segment template is selected for each segment (e.g., a customer template, an account template, a channel template, an authentication template, an activity template).

Once templates are selected at 406, the segments are generated and populated according to the selected templates at 410 with data from the received transaction 404. The populated segments 412 are provided for storage in one or more data stores 414. The enterprise data contained in the one or more data stores 414 may then be aggregated, scored, or otherwise analyzed at 416 to provide an enterprise data score 418. For example, data associated with the transaction from the customer segment, the activity segment, and the channel segment may be provided to a predictive model for scoring.

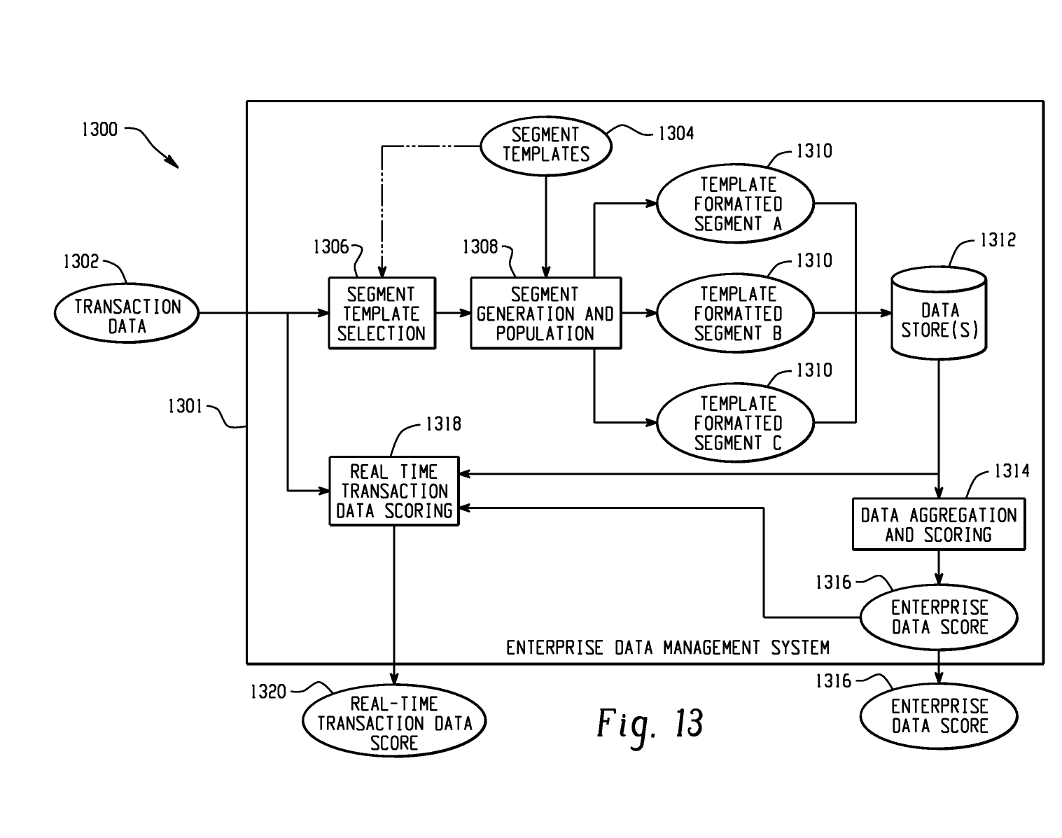

In another embodiment, transaction data 404 may be received from a data provider in an already template formatted segment state. A client may perform segment template selection 406 and segment generation and population 410 based on details of a transaction for which the client wishes to provide data, or the client may use a consistent set of templates for a particular type of transaction or transactions that the client performs. In such a case, the enterprise data management system 402 may receive the formatted data and store the formatted data in the data store(s) 414 with little or no processing. Such a configuration is shown and described in detail in FIG. 11. As a further example, and as described in further detail herein at FIG. 13, received transaction data 404 may be scored prior to long term storage in addition to any subsequent scoring, such as the scoring performed at 416.

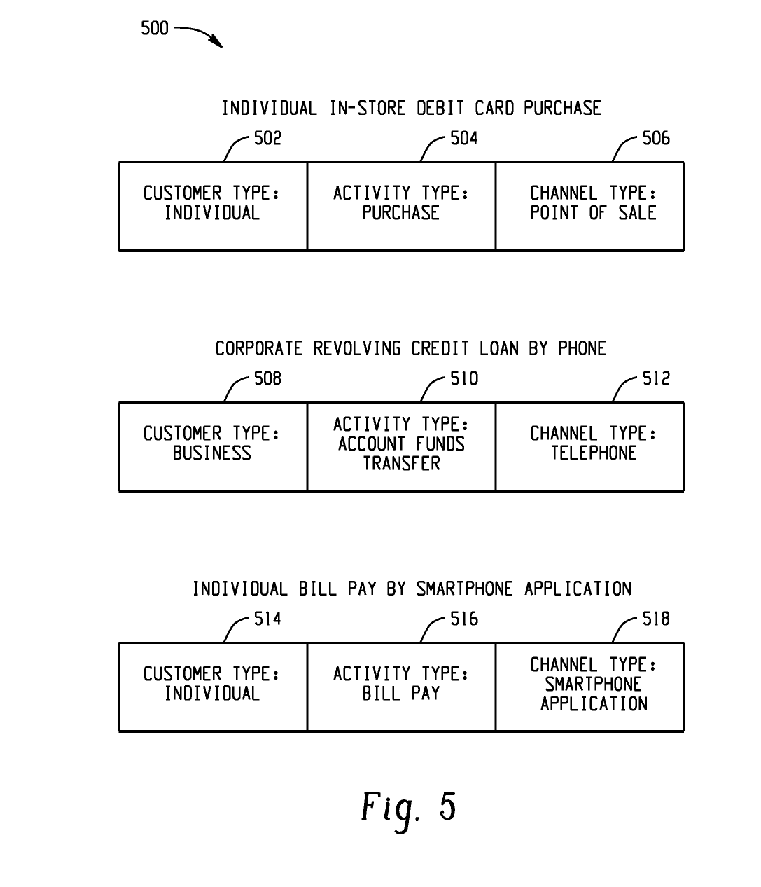

FIG. 5 depicts example attributes for different transaction segments. FIG. 5 first depicts an in-store debit card purchase by an individual. This transaction has an individual attribute 502 for the customer type segment, a purchase attribute 504 for the activity type segment, and a point of sale attribute 506 for the channel type segment. Other attributes may be used to describe other segments for the transaction. For example, a debit card attribute may be associated with the account type segment for the transaction. As a second example, a corporate revolving credit loan secured by phone may have a business attribute 508 for the customer type segment, an account funds transfer attribute 510 for the activity type segment, and a telephone attribute 512 for the channel type segment. As a further example, an individual bill pay by smartphone application may have an individual attribute 514 for the customer type segment, a bill pay attribute 516 for the activity type segment, and a smartphone application attribute 518 for the channel type segment.

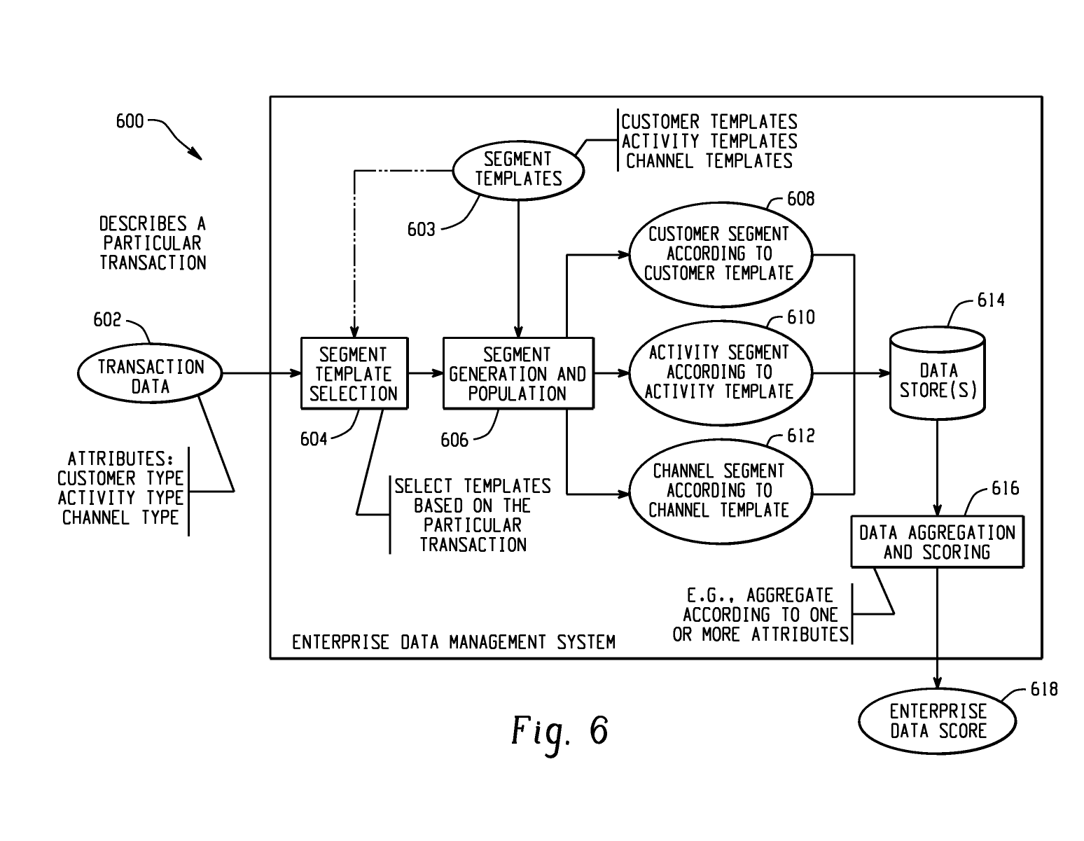

FIG. 6 is a block diagram depicting an example enterprise data management system. Transaction data 602 representative of a particular transaction that has occurred is received. The transaction data includes attributes describing the particular transaction such as a customer type, an activity type, and a channel type. Segment templates 603 are selected at 604 based on the attributes of the transaction data. For example, a customer template may be selected based on the customer type, an activity template may be selected according to an activity type, and a channel template may be selected based on a channel type. At 606, the segments are generated and populated according to the selected templates. The segments 608, 610, 612 may then be provided to one or more data stores 614 for storage. At 616, the data from the data stores may be extracted, aggregated, and scored to generate one or more enterprise data stores 618. For example, the data may be extracted and aggregated according to one or more attributes. For example, the data may be aggregated according to a particular channel, such as a particular automated teller machine (ATM). Aggregate data for that ATM may be analyzed to determine a high occurrence of fraud (e.g., withdrawals using false debit cards) associated with that ATM. Based on that determination, future transactions associated with that ATM may be flagged as potentially fraudulent.

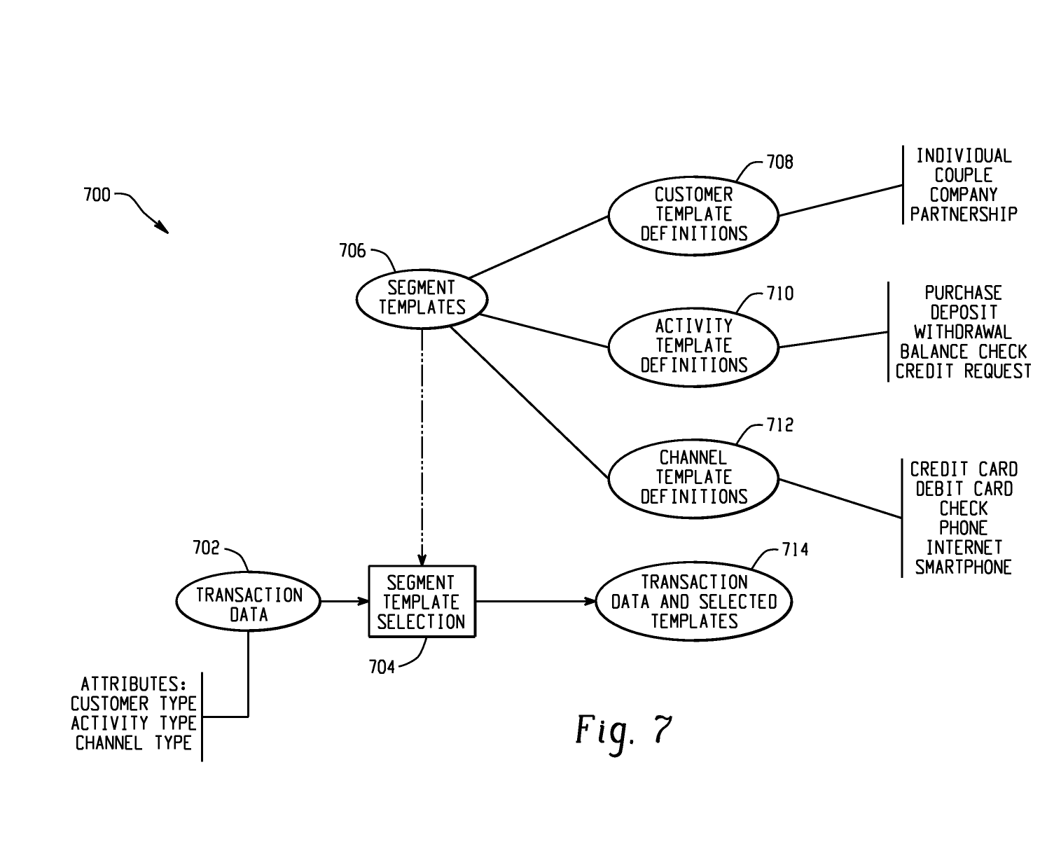

FIG. 7 is a block diagram depicting segment template selection. Transaction data 702, such as data associated with a particular transaction is received. That transaction data may include certain attributes of a particular transaction, such as a customer type, an activity type, and a channel type. During template selection the attributes of the transaction data 702 are used to determine proper segment templates 706 to use to store data associated with the transaction. For example, the segment templates 706 may include a number of customer template definitions 708. Those customer template definitions 708 may include an individual template, a couple template, a company template, and a partnership template. A customer template definition 708 may be selected to match the customer type of the transaction data. As another example, the segment templates 706 may include a number of activity template definitions 710. Those customer template definitions 710 may include a purchase template, a deposit template, a withdrawal template, a balance check template and a credit request template. An activity template definition 710 may be selected to match the activity type of the transaction data. As a further example, the segment templates 706 may include a number of channel template definitions 712. Those channel template definitions 712 may include a credit card template, a debit template, a check template, a phone template, a smartphone template and an Internet template. A channel template definition 712 may be selected to match the channel type of the transaction data. The transaction data and selected templates 714 are provided for population of segments and segment storage.

The modular design illustrated in FIG. 7 enables an enterprise data management system to offer increased data storage flexibility by providing a number of different templates for different segments as well as the ability to add or modify templates at a future time. Storing segments according to templates enables storage of data related to many different types of transactions (e.g., number of templates for segment A*number of segments for segment B* . . . *number of segments for segment n disparate types of transactions). Certain of these large number of transactions (e.g., thousands) formed by combinations of segments formatted according to templates may be disallowed for being logically improper as a form of error checking (e.g., a check payment activity at a card reader terminal channel). This enables providers of an enterprise data management system or users of an enterprise data management system to tailor enterprise data management to a current state of affairs when that current state of affairs is not known at the time of system deployment.

The advantage of the enterprise data management system over traditional systems may be illustrated by analogy. Traditional symbols are like a logographic writing system (e.g., Chinese) in which symbols stand for individual words. A unique layout must be created for each of the transaction type that one wishes to track. The enterprise data management system is like an alphabet writing system where the segments and templates provide much more manageable alphabet that can be used to describe the many possible disparate transaction types.

For example, in a banking example, a number of channel templates may initially be included in a set of provided segment templates. If future technology allowed purchases and other transactions to be accomplished using a microchip implanted in a consumer's hand, the flexible design of the enterprise data management system enables tracking of such transactions without substantial changes to data storage schemas. By adding a new channel template that tracks certain data related to an implanted microchip channel (e.g., microchip identifier, microchip expiration date), transaction data related to an implanted microchip transaction can be stored along with transaction data associated with currently known channel types. This added functionality can be implemented without requiring any changes to customer, activity, or other templates.

Templates may also be edited as necessary or desired. For example, a bank may decide that they wish to track a driver's license number in addition to a social security number for individual customers. The individual customer template can be edited to add a driver's license number field to accomplish this transition. No edits need to be made to other templates to accomplish this change.

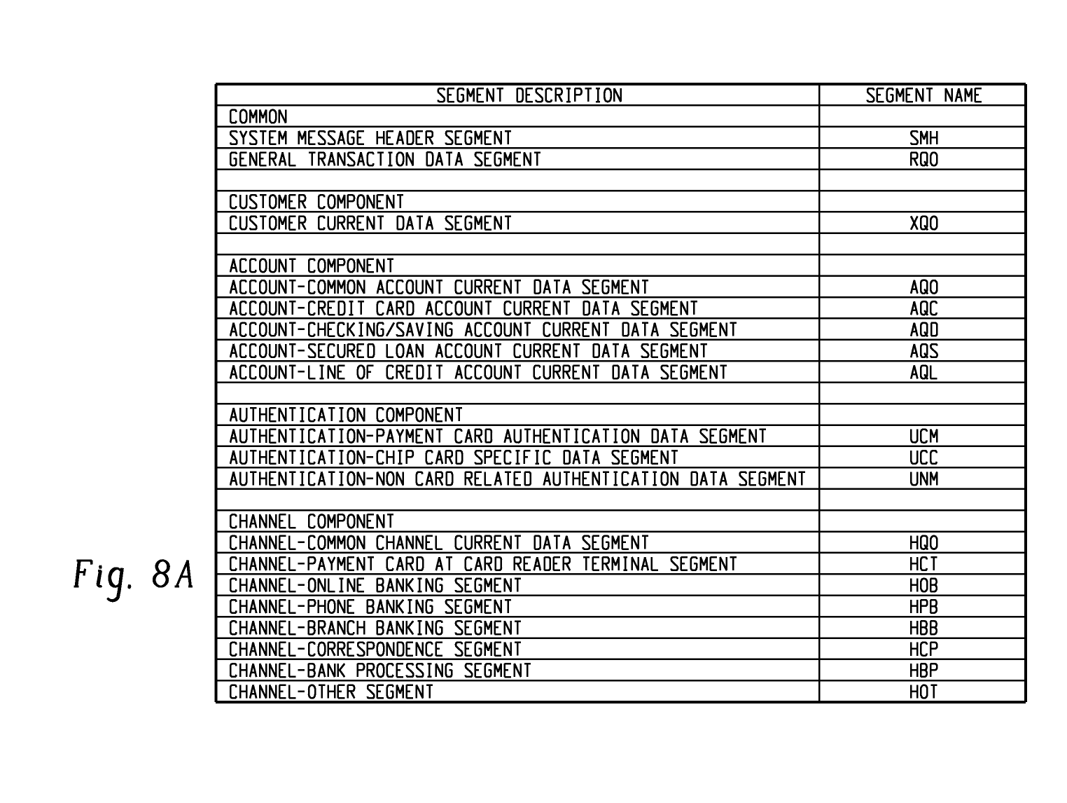

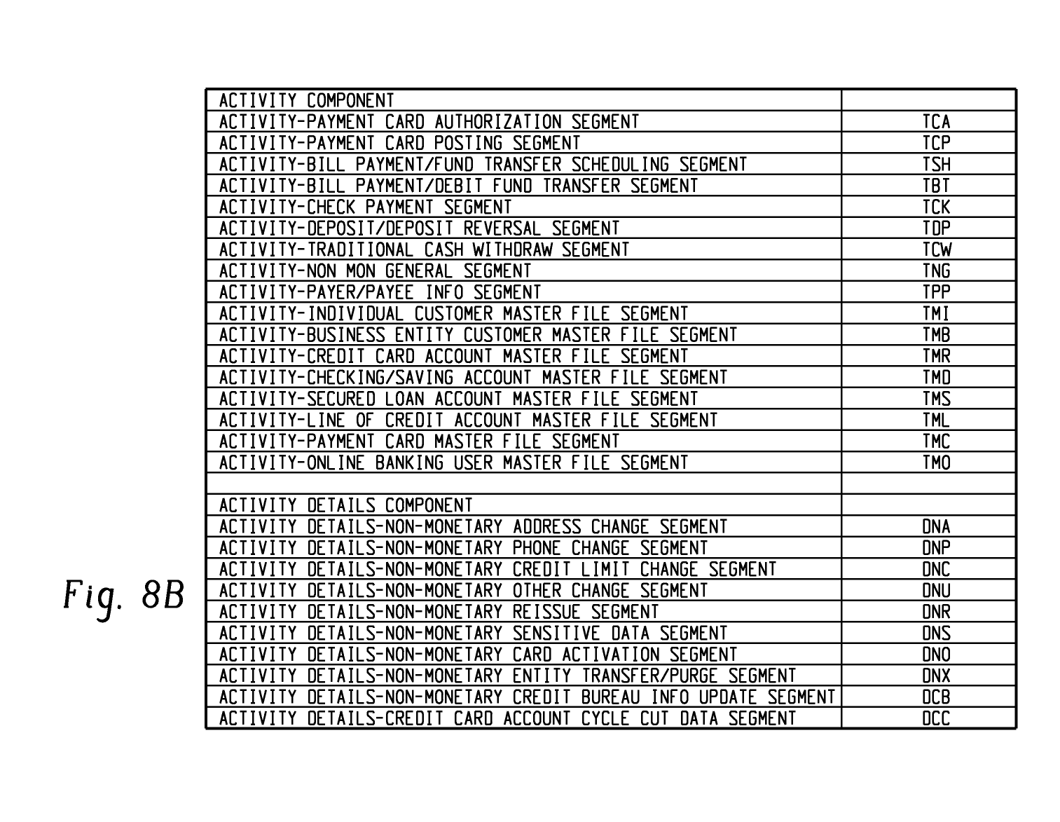

FIGS. 8A and 8B depict example templates for segment storage. Templates are presented for each of a number of segments. For example, an account component segment includes a number of templates for storage of transaction data associated with different types of accounts. For example, if transaction data is received for a line of credit transaction, then the AQL template may be selected for storage of account data for that transaction. As another example, if a transaction is made using branch banking, then the HBB template may be used to structure the channel segment. As a further example, if the transaction is a check payment, then the TCK template may be used to structure the activity segment.

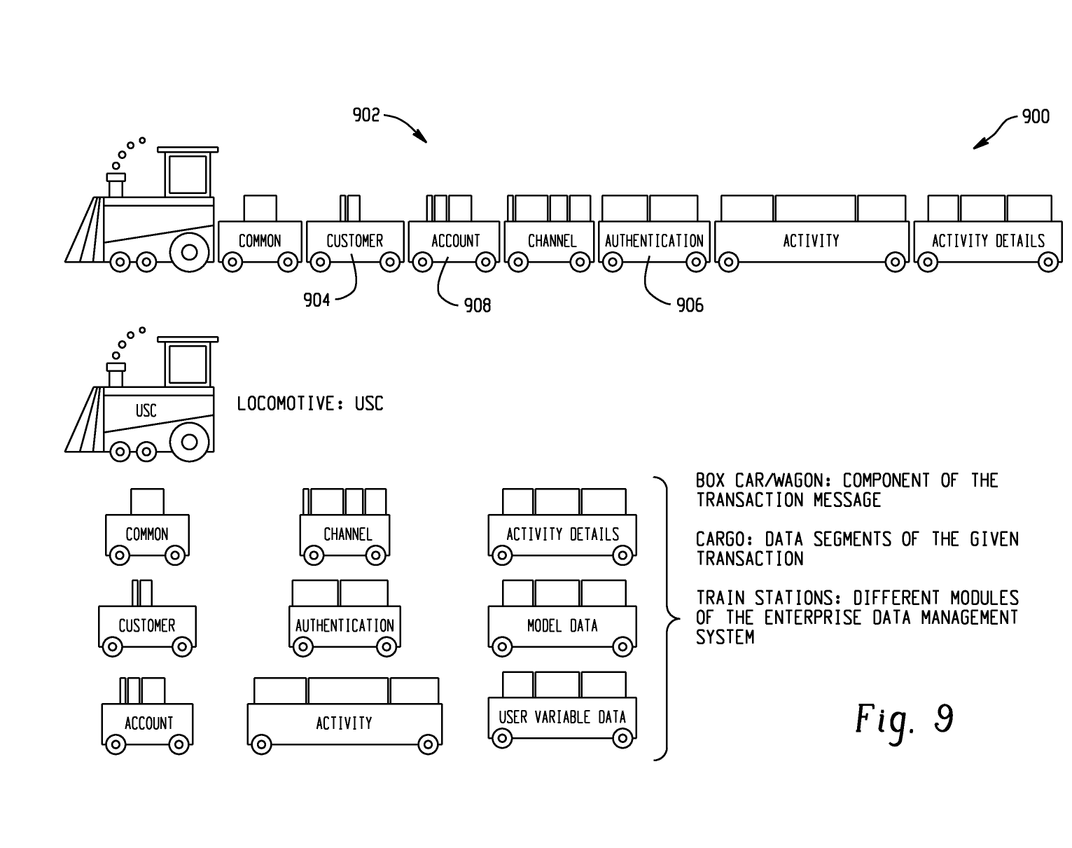

FIG. 9 is a diagram depicting an example visualization for describing one form of storage that may be used by an enterprise data management system. Formatting and storage of transaction data may be visualized using a cargo train model. In the visualization, transaction data associated with a particular transaction may be stored using a number of cars 902. Each of the cars 902 is associated with a segment. For example, a customer segment car 904 is used for holding data related to a customer associated with the transaction, and an authentication segment car 906 is used for holding data related to authentication (e.g., customer authentication via a personal identification number). A cargo train may transport data between portions of an enterprise data management system to facilitate enterprise data management system functions (e.g., data scoring).

When transaction data is received, one or more templates are selected for each of the cars 902 of the cargo train based on attributes of the particular transaction associated with the transaction data. Thus, a customer template is selected for the customer segment car 904, and an account template is selected for the account segment car 908, with one or more templates being selected and populated for each of a plurality of the cars. Different templates may include different numbers and formats of fields used for storage. For example, an individual customer template may have 3 integer fields and 5 text string fields, while a company customer template may have 5 integer fields, 1 long integer field, 4 text string fields, 2 Boolean fields, and 1 real number field. Segments cars are filled using transaction data according to selected templates and are provided for storage according to those templates.

Different cargo trains may have different numbers of cars depending on parameters of a desired application. Cargo trains may have more or fewer cars for containing data stored according to templates than depicted. Segments may have one or more templates from which to select. Some segments may always be stored according to the same one or more templates. For example, a common data segment may contain general (e.g., header) information about a particular transaction. A common data segment may contain information about which templates are used to store data for other segments associated with a particular segment. A common segment may also contain data associated with a date and time associated with the transaction. Because these types of common data are constant across many/all transaction types, all common segments may be stored according to a limited number of common segment templates (e.g., 1 or 2).

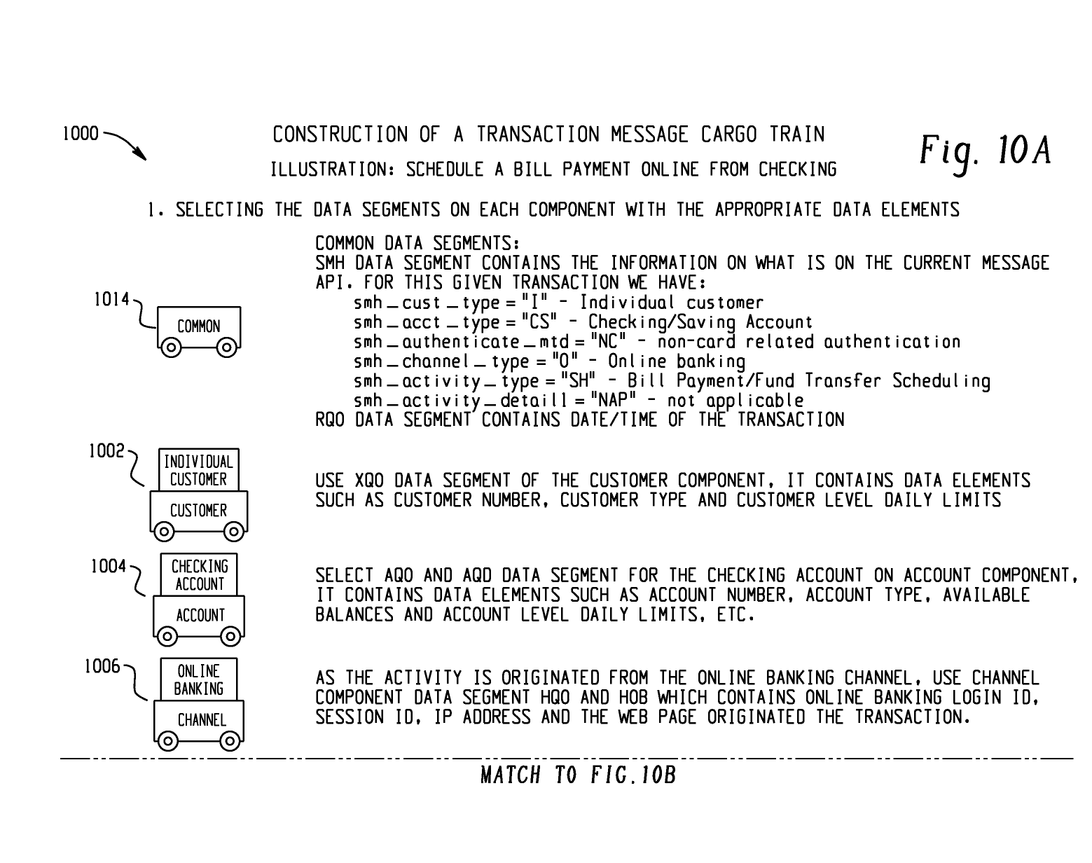

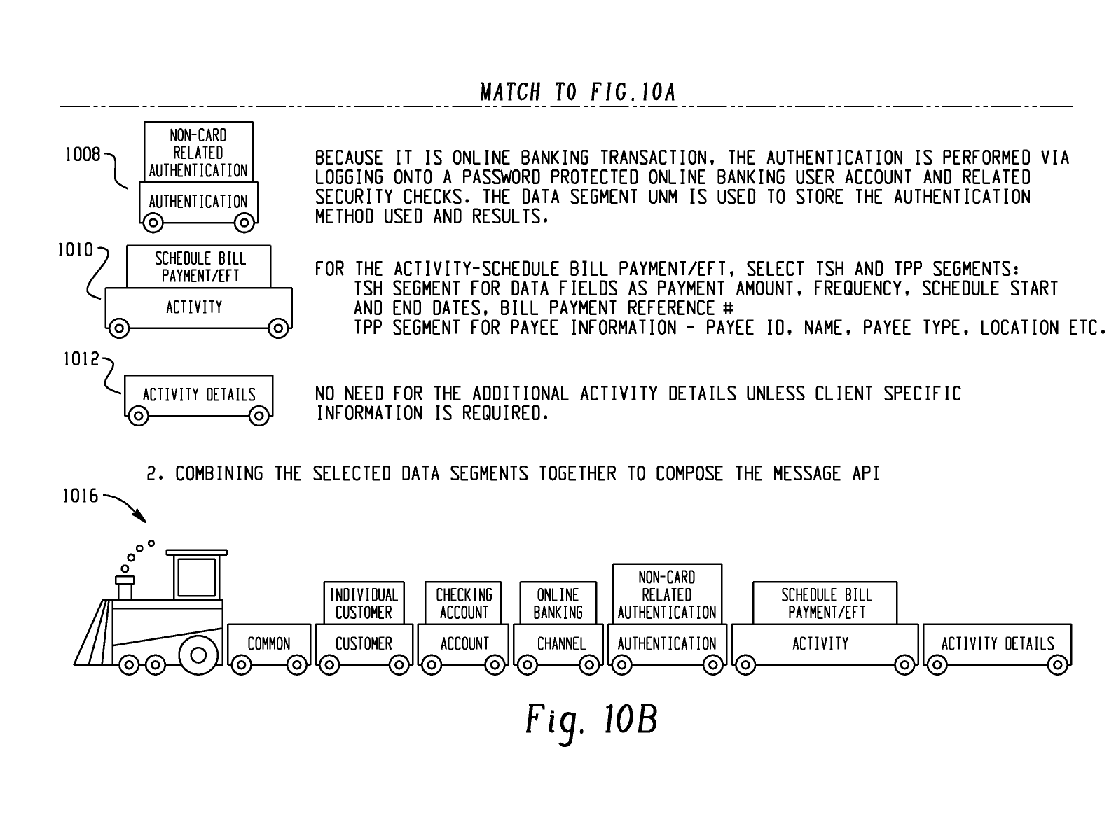

FIG. 10 depicts an example construction of a transaction message cargo train. Transaction data is received for a scheduling of a bill payment from a checking account made online. An individual customer template is selected for the customer segment 1002. The customer segment car formatted according to the individual customer segment contains data elements such as a customer number, a customer type, and customer level daily limits. The customer number may be used in place of explicit customer data (e.g., name, address) as a reference to another customer record that stores that data. This results in storage savings, as the customer name, address, and other data, which are often constant across many transactions, do not need to be explicitly stored in each customer segment. Similar references may be used in other segments of the cargo train.

Two checking account templates are selected for the account segment 1004 (i.e., the AQO and AQD templates). The account segment is populated according to those templates and contains data such as an account number, an account type, available balances, and account level daily limits. Two online banking channel templates are selected for the channel segment 1006 (i.e., the HQO and HOB templates). The channel segment is populated according to those templates and contains data such as an online banking login identifier, a session identifier, an IP address, and a web page that originated the transaction. A non-card related authentication template is selected for the authentication segment 1008. Because the transaction is an online banking transaction, the authentication is performed via logging onto a password protected online banking customer account and related security checks. The UNM authentication segment template is used to store the authentication method used and results. Two schedule bill payment/EFT templates are selected for the activity segment 1010 (i.e., the TSH and TPP templates). The activity segment is populated according to those templates and contains data such as payment amount, frequency, schedule start and end dates, bill payment reference number, payee identifier, payee name, payee type, payee location. In the present example, no template is selected and no data is stored for the activity details segment 1012. This segment may be used for storing other data related to the transaction activity, such as certain data that a specific client wishes to track.

After templates have been selected for each of the segments, a common data segment 1014 is populated using the SMH and RQO templates. In this example, the common data segment is populated with data related to the particular transaction such as the customer type, account type, authentication type, channel type, activity type, and a date and time associated with the transaction. The populated data segments may be combined, as shown at 1016 for transport to certain portions of the enterprise data management system, such as one or more data stores for storage.

FIG. 11 is a block diagram depicting processing of bank transactions using an enterprise data management system. A bank receives many transactions 1102, some of which originate from a customer (e.g., an individual, a business) and some of which initiate from the bank itself. The bank, a client, in the example of FIG. 11 uses a provided API schema 1104 to format transactions in a standard format using segments. The same segments may be used for very different transactions or activities.

In the example of FIG. 11, up to seven segments are used to describe a transaction. A common segment includes data such as date and time of the transaction as well as identifying information that allows the enterprise data management system to parse the transaction (e.g., segments included and template types selected for the transaction). A customer segment identifies what type of customer is performing the transaction (e.g., a business or an individual). An account segment identifies what type of account (if any) is originating the transaction (e.g., checking or savings, credit card, line of credit). An authentication segment identifies what type of authentication (if any) was performed to authenticate the customer (e.g., details from a credit card, chip card, username/password combination). A channel segment identifies the channel over which the transaction took place (if any) (e.g., internal bank processing, card terminal, bank webpage, bank phone system, mail). An activity segment identifies the activity that the transaction represented (e.g., card authorization, bill payment, funds transfer, non-monetary, master file). An activity details segment includes optional additional details about the activity that may be useful to the transaction (e.g., details of non-monetary activity such as old and new address, sensitive data, details about check processing).

The example of FIG. 11 depicts several transactions 1102 being received for processing. The bank systems 1106 apply the API schema 1104 to describe the received transactions 1102 in segments according to selected templates 1108. For example, one transaction is a cash withdrawal at an ATM. The bank systems 1106 receive details of the transaction and generates a common segment, a customer segment according to template X₁ for an individual customer, an account segment according to template A₁ for a checking account, an authentication segment according to U₁ for a personal identification number authentication, a channel segment according to H₁ for an ATM transaction, and an activity segment according to T₁ for a cash withdrawal.

Another example depicts a monthly account statement being sent to a business customer. The bank systems 1106 apply the API schema 1104 to describe the transaction in segments according to the selected templates 1108. The bank systems 1106 generate a common segment, a customer segment according to template X₂ for a business customer, an account segment according to template A₂ for a business account, a channel segment according to template H₄ for the mail channel, and an activity segment according to template T₅ for a monthly statement mailing activity.

The transactions are transmitted to a Universal SAS Connector (USC) 1110. The USC retrieves signatures from the signature database according to specific key fields (e.g., account number, card number, terminal identifier). A transaction and signature are forwarded to an on demand scoring engine (OSE) 1114. The OSE parses the transaction and splits the segments into individual fields. The OSE then commands the execution of scoring code. The scoring code commands execution of the appropriate scoring models 1116 to score the transaction. Multiple scores may be generated for a given transaction. The generated scores are returned to the OSE 1114. The OSE 1114 may process client defined rules and transmit results to the USC 1110. The USC may transmit updated signatures to the signature database 1112, and a copy of the transaction may be forwarded to a reporting history database 1118.

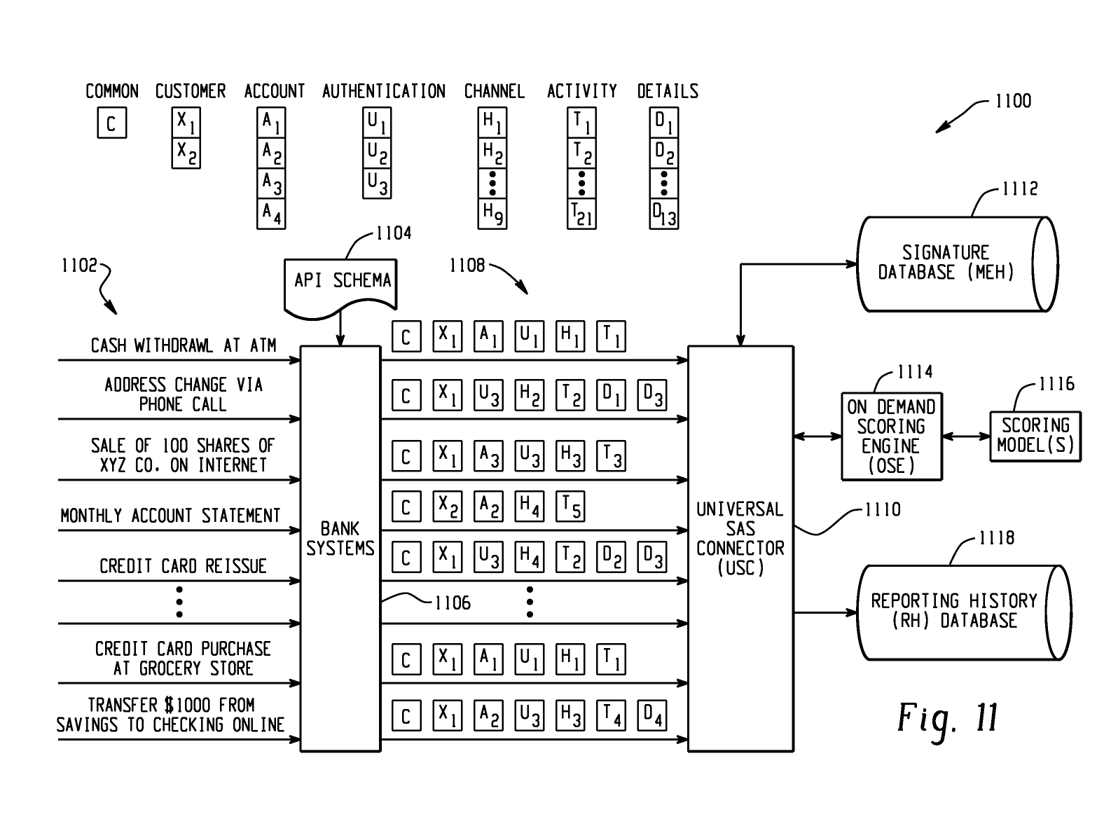

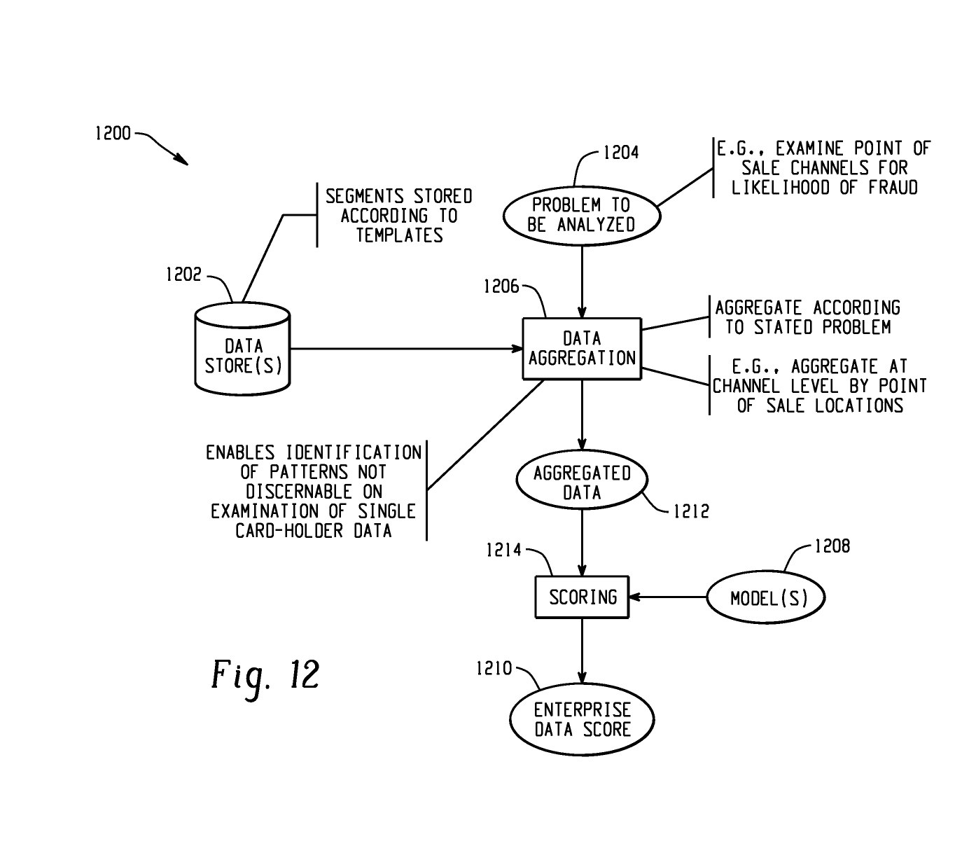

FIG. 12 is a block diagram depicting example scoring of transaction data representative of transactions of disparate types. Transaction data describing a particular transaction is received. The transaction data is stored in a data store 1202 in a plurality of segments, where a segment is formatted according to a template, and where the template is selected based on an attribute of the transaction, such as a customer attribute, an activity attribute, or a channel attribute. A problem to be analyzed is identified at 1204. For example, it may be desired to analyze whether there is an unexpected level of fraud associated with one or more points of sale. At 1206, data from the data store 1202 is extracted and aggregated 1206 at a point of sale level for scoring.

For example, a model 1208 may accept certain inputs used to provide an enterprise data score 1210 (e.g., a fraud likelihood score). A metadata data extraction map may be used to direct extraction of data from the data store 1202 that is stored in segments according to different templates so that values for different model inputs can utilized by the model 1208 to generate one or more enterprise data scores 1210. The extracted data may then be aggregated at 1206 according to the problem being analyzed. Aggregation may be according to a number of parameters. For example, a number of raw data values to be used for different inputs to the model 1208 may be specified (e.g., aggregate and average the last 100 transaction values for a particular point of sale location).

To analyze whether certain point of sale locations have a high association with fraud, the extracted data may be aggregated at the channel level according to point of sale locations. The aggregated data 1212 may be scored at 1214 by one or more models 1208 to generate one or more enterprise data scores 1210. For example, an enterprise data score 1210 may be generated for each of a plurality of point of sale locations identifying a level of fraud associated with those locations.

Providing scoring of aggregated data offers a number of advantages. For example, scoring aggregated data enables identification of patterns not discernable on examination of non-aggregated data, such as single credit card-holder data. For a single account holder who has been defrauded (e.g., credit card or identity stolen), it may be difficult to pinpoint an exact transaction from which the fraud initiated. However, analysis of aggregated data can bring certain patterns to light that may be otherwise unseen. For example, aggregating data at the channel level by point of sale locations may identify that a certain point of sale location is common among a number of defrauded customers (e.g., an unscrupulous shop owner steals a credit card number of one individual and one company customer, checking account and routing numbers for one company customer, and debit card numbers for two individual customers). Looking at each of these customers in isolation may not identify the origin of the fraud. Additionally, looking at data aggregated at the point of sale channel level for each of the customer/account types may not identify the origin of the fraud because of the limited number of fraudulent transactions at the point of sale location using each customer/account type (i.e., one individual credit card account, one company credit card account, one company checking account, and two individual debit card accounts). However, analyzing data aggregated at the channel level by point of sale location enables identification of this example fraud by compiling enough data related to that point of sale (e.g., all five of the above described fraudulent transactions) to identify the pattern.

Such aggregation and analysis is not possible using traditional systems. Traditional systems do not offer the flexibility to store transaction data associated with a large number of disparate transaction types (e.g., in a single data store). Thus, each of the different transaction types must be analyzed in isolation. If one would desire to analyze across disparate transaction types, significant work would be required to extract the data for disparate transaction types from different data stores that are stored according to differing schemas. The enterprise data management system provides centralized storage of transaction data associated with potentially thousands of different transaction types. Such centralized storage with capacity to extract model input fields and aggregate them at different levels (e.g., segments according to segment attributes), enables much more powerful analysis capability over systems storing transaction data for individual transaction types in isolation.

FIG. 13 is a block diagram depicting example real-time scoring of received transaction data. Transaction data 1302 is received by an enterprise data management system 1301 and prepared for storage. For example segment templates 1304 may be selected at 1306 based on attributes of the transaction data, and the segments may be populated according to selected templates at 1308. The populated segments 1310 are then stored in one or more data stores 1312.

At 1314, data from the stored segments may be aggregated and scored to generate an enterprise data score 1316. For example, a particular problem may be analyzed that utilizes data aggregated at a certain segment level (e.g., the authorization segment level by authorization type). The aggregate data score 1316 generated by a model may be output. Additionally, the aggregate data score 1316 and/or other data from the data store 1312 may be used to train a real-time predictive scoring model 1318. For example, a real-time data scoring operation 1318 may seek to generate a likelihood of fraud score for received transaction data 1302 associated with a particular transaction. Previously, a data aggregation and scoring operation 1314, has utilized data aggregated at the authorization segment level by authorization type to discover that several transactions using the public key infrastructure (PKI) for authentication are associated with fraud. This discovery is manifest in an aggregated data score 1316 for the PKI authentication type. The real-time transaction data scoring model may be trained using the aggregated data score 1316 for the PKI authentication type. Thus, received transaction data 1302 for transactions using PKI authentication may be assigned a higher likelihood of fraud real-time transaction data score 1320 based on the discovery in data aggregation and scoring 1314.

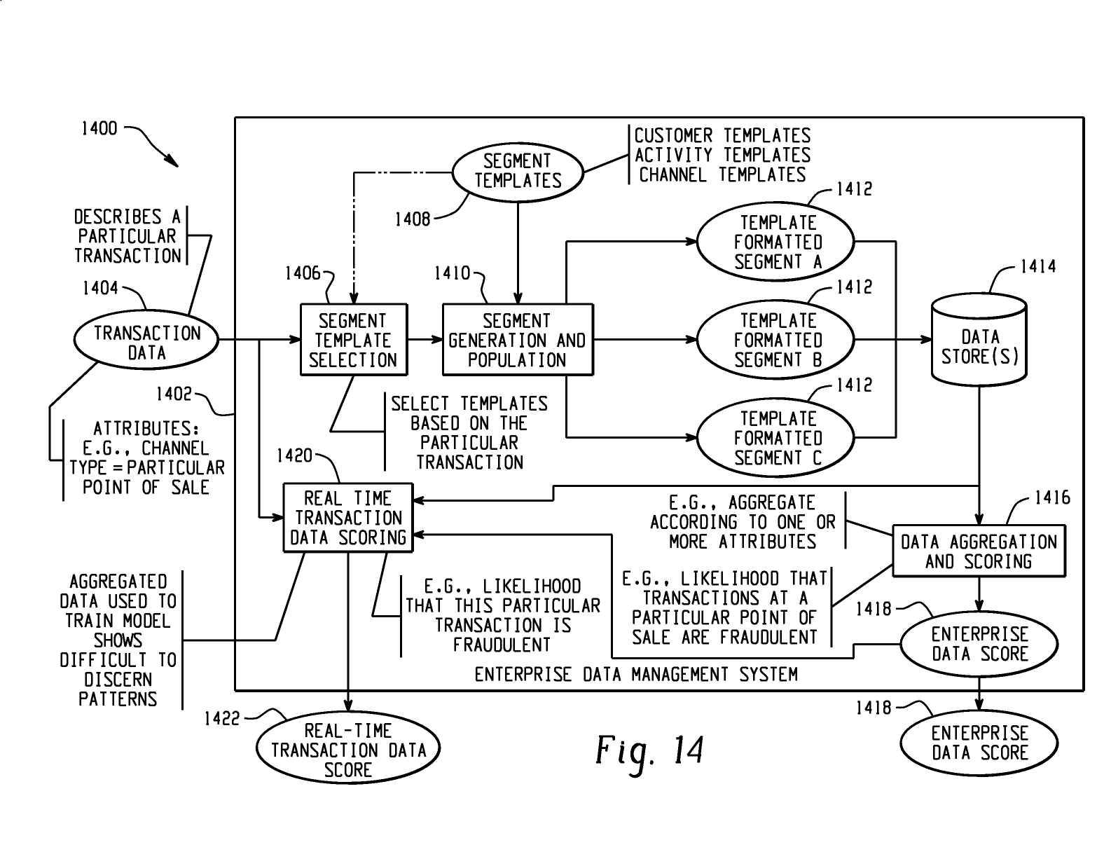

FIG. 14 is a block diagram depicting example aggregate data and real-time scoring of received transaction data. An enterprise data management system 1402 receives transaction data 1404 describing a particular transaction having attributes, such as a channel type that identifies a particular point of sale. At 1406, segment templates 1408 are selected for segments of the transaction based on the attributes of the particular transaction. At 1410, the segments are generated, formatted according to the selected segment templates 1408, and populated with data from the received transaction data 1404. The template formatted segments 1412 are stored in one or more data stores 1414.

Data from the one or more data stores 1414 may be extracted, aggregated, and scored at 1416. For example, extracted data may be aggregated according to one or more attributes. In one example, an identification of the likelihood that transactions at different points of sale are fraudulent is sought. Data may be extracted from stored segments from the one or more data stores 1414 and aggregated at the channel level according to point of sale locations. The aggregated data may be scored by one or more models to generate an enterprise data score 1418. The enterprise data score 1418 may have value in itself and be outputted. For example, a listing of point of sale locations associated with fraud may be used as a list of locations to investigate for purposes of fraud recovery.

The enterprise data score 1418 may also have value in identifying future fraud. Thus, the enterprise data score 1418 may be provided for training a predictive model for evaluating real-time transaction data at 1420. The use of the enterprise data score 1418 may enable the real-time transaction data scoring model to act on patterns that may be unrecognizable using data directly from the data store 1414 alone. One or more real-time transaction data scoring models receive transaction data 1404 at 1420 to provide one or more real-time transaction data scores 1422. For example, the real-time transaction data score may be a real-number value between 0 and 1 identifying a likelihood of the new transaction being scored is associated with fraud. Transactions associated with point of sale locations associated with fraud by the data aggregation and scoring 1416 may receive higher real-time transaction data score fraud indications.

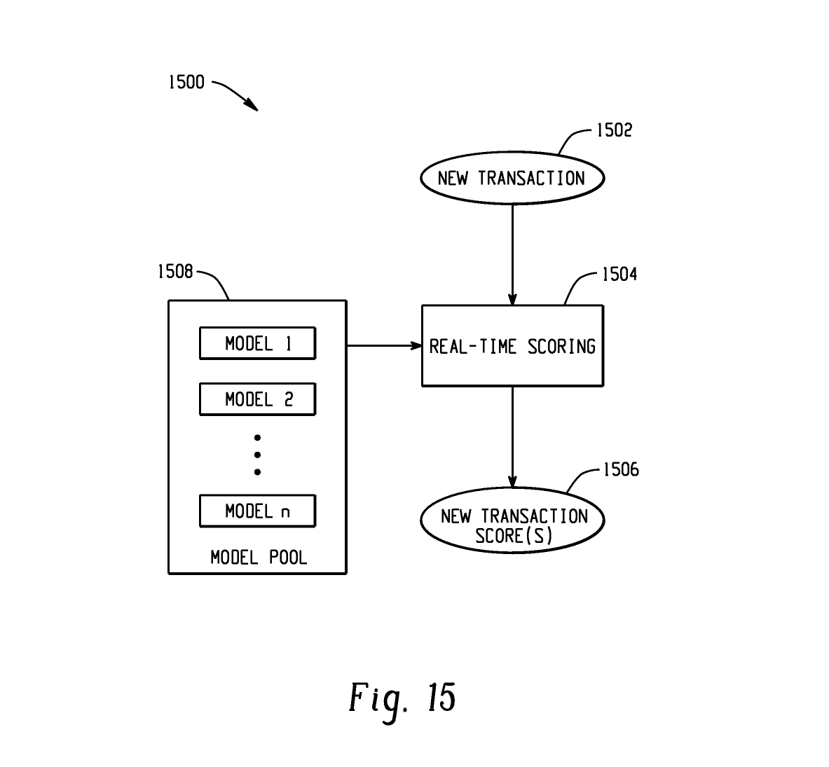

The combined storage of several different types of transaction data offers an enhanced platform for providing many different types of analyses. FIG. 15 is block diagram depicting model selection for real-time scoring of transaction data. New transaction data 1502 is received for real-time scoring at 1504. It may be desirable to perform one or more types of scoring for the new transaction based on a type associated with the new transaction. For example, one may wish to perform both fraud and authorization scoring for a newly received credit card transaction. The fraud scoring provides a transaction score 1506 identifying a likelihood that the credit card transaction is fraudulent. The authorization scoring provides a score indicating whether the credit card transaction should be authorized (e.g., based on a credit limit, outstanding balance, and payment history). Upon receipt of the credit card transaction data, the real-time scoring selects an appropriate fraud scoring model and authorization scoring model from a model pool 1508 containing a plurality of models to generate the new transaction scores 1506.

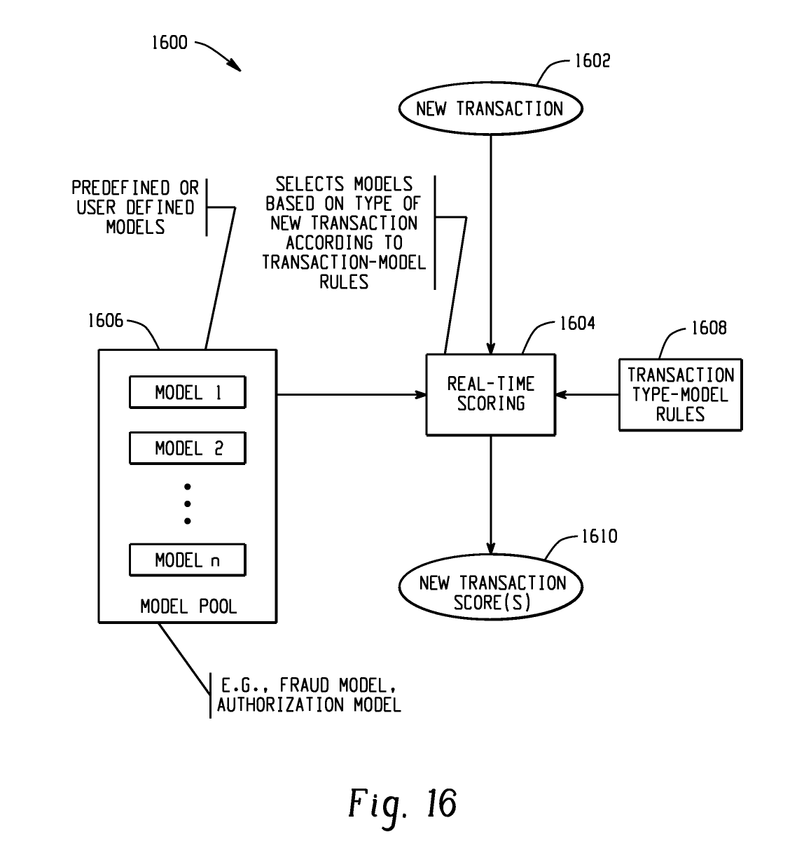

FIG. 16 is a block diagram depicting generation of a real-time transaction score. Transaction data 1602 describing a particular transaction that has occurred is received. The transaction data 1602 may be stored in an enterprise database that stores transactions of disparate types using segments formatted according to templates. During real-time scoring 1604, a transaction type for the new transaction 1602 is determined. One or more models are selected from a pool of predefined or user defined models 1606 based on the determined transaction type, such as using a set of transaction type-model rules 1608. The one or more selected models are trained based on records from the enterprise data base. Using the one or more selected models, the new transaction data 1602 is scored to generate one or more new transaction scores 1610.

For example, the new transaction 1602 may be an Internet banking password change. Upon receipt of the new transaction 1602, the real-time scoring 1604 determines the type of transaction, consults the transaction type-model rules 1608, and selects a model from the pool of models 1606. In this example, a fraud likelihood predictive model is selected. The transaction type-model rules dictate that an authorization model is not selected because for this transaction, there is no monetary transaction to authorize. The real-time scoring applies the fraud likelihood predictive model to generate a score 1610 identifying whether the password change is likely fraudulent. If the password change is likely fraudulent, then the change may be prohibited. If the transaction score 1610 identifies a low likelihood of fraud, then the password change may be allowed.

As another example, the new transaction 1602 may be an ATM withdrawal. The real-time scoring 1604 determines the type of transaction, consults the transaction type-model rules 1608, and selects a fraud model and an authorization model from the pool of models. The authorization model scores the model and provides a score 1610. The fraud model has been trained using data from the enterprise database. The data from the enterprise database has identified the ATM associated with the new transaction 1602 as having a high association with fraud. Thus, this identification from the data in the enterprise database influences the fraud likelihood score 1610 for the new transaction 1602, making the score 1610 higher than it would be without the model training using the enterprise database data.

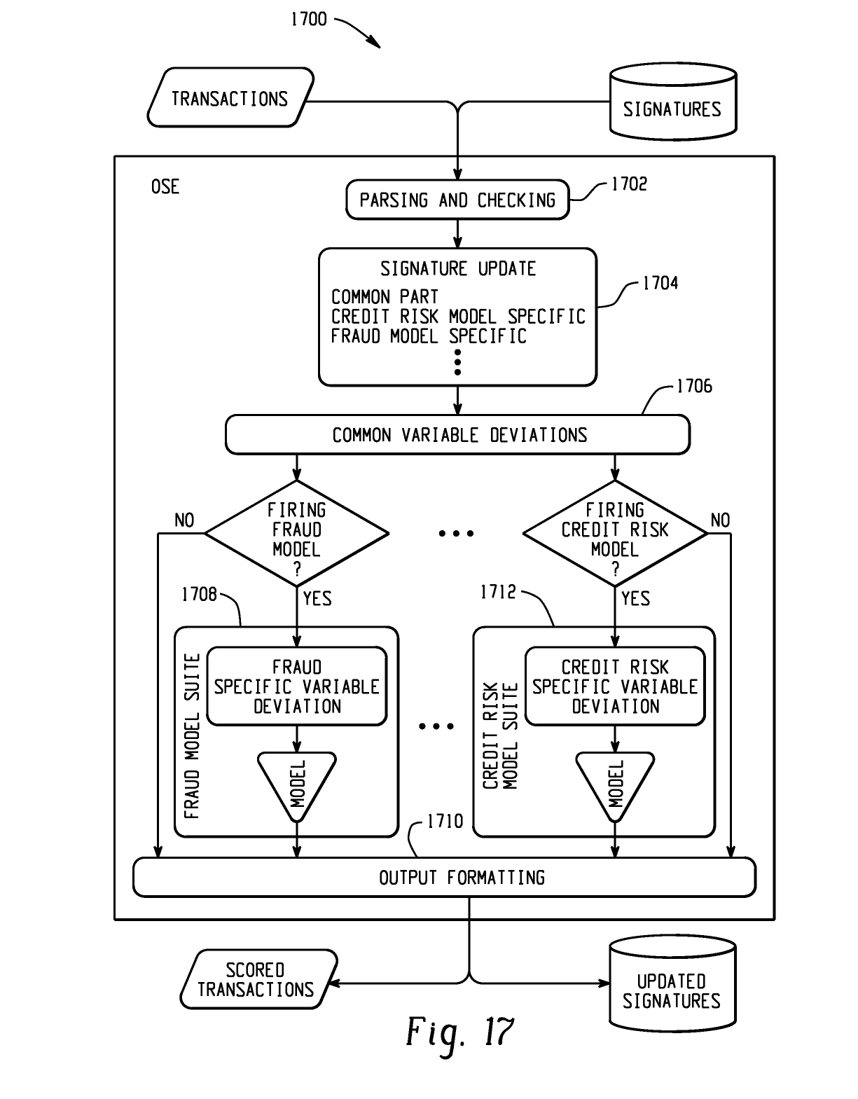

FIG. 17 is a block diagram depicting deployment of multiple scoring models to support decisioning on various aspects of different banking products. Unlike traditional systems that require a separate data feed and layout for each scoring model, the enterprise data management system may use models that operate using a common data feed. Moreover, the data may be used across different models to provide a holistic view of the scoring entities. FIG. 17 depicts multiple models working within a single online scoring engine (OSE).

Transaction data is received, and parsed and checked at 1702. Data may be extracted according to the inputs needed for each of the models relevant to the current transaction 1704, 1706. If the fraud model is to be used, then the fraud model suite 1708 is accessed, the transaction data is scored, and the scored transaction is outputted at 1710. If the credit risk model is to be used, then the credit risk model suite 1408 is accessed, the transaction data is scored, and the scored transaction is outputted at 1710.

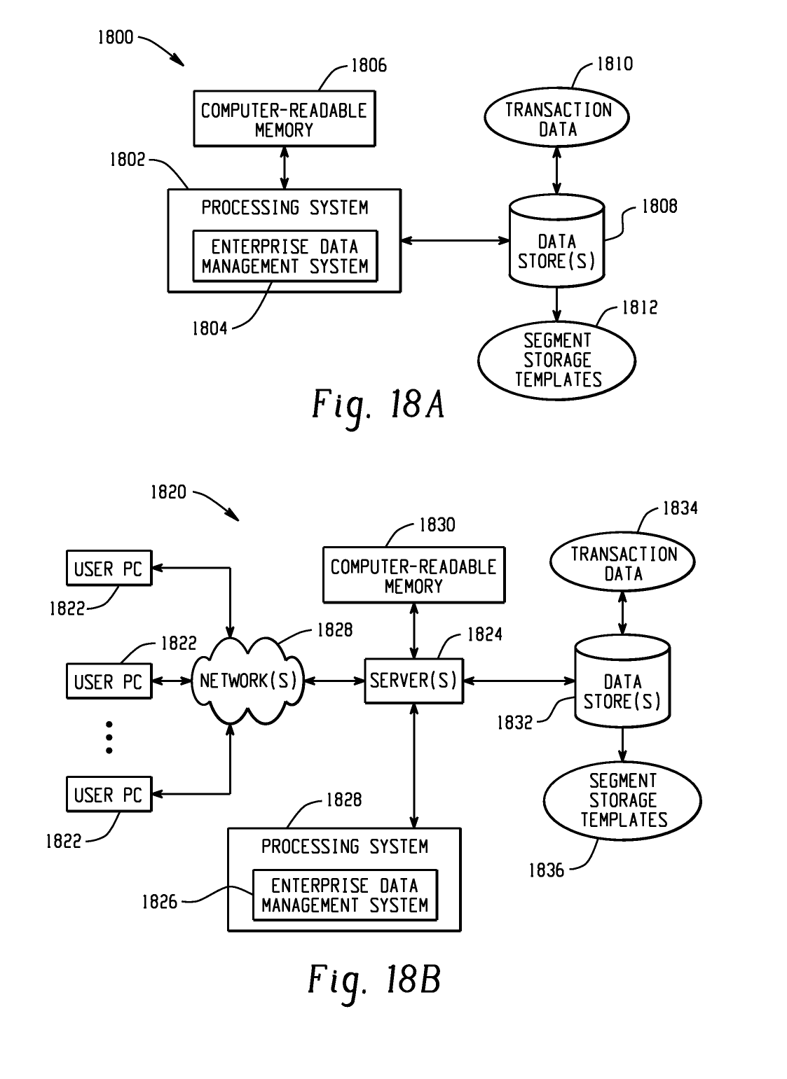

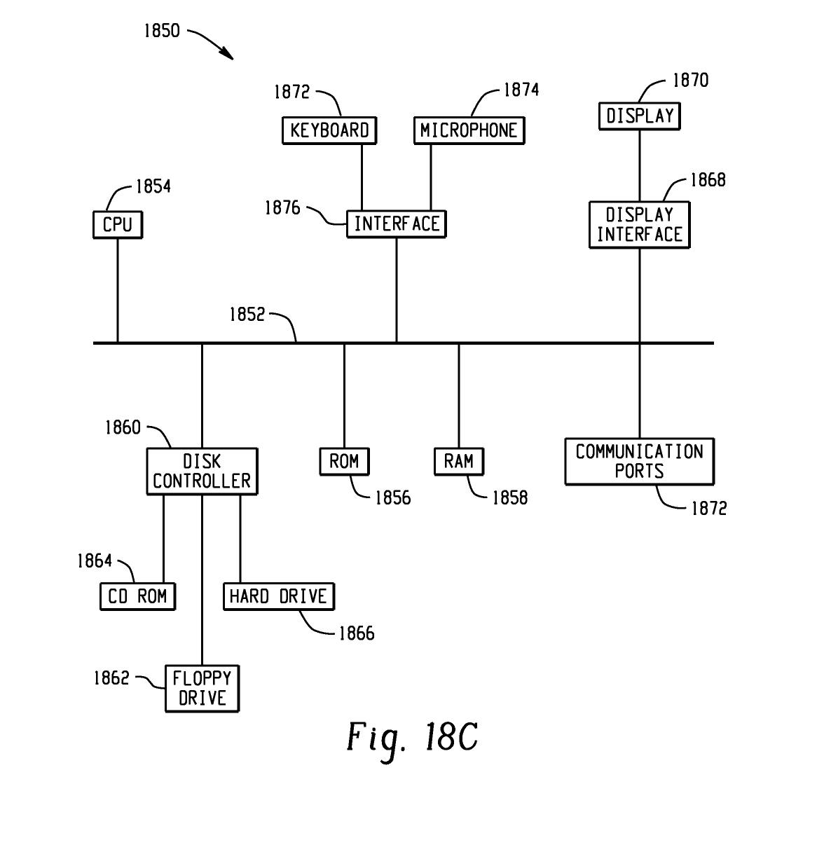

FIGS. 18A, 18B, and 18C depict example systems for use in implementing an enterprise data management system. For example, FIG. 18A depicts an exemplary system 1800 that includes a standalone computer architecture where a processing system 1802 (e.g., one or more computer processors) includes an enterprise data management system 1804 being executed on it. The processing system 1802 has access to a computer-readable memory 1806 in addition to one or more data stores 1808. The one or more data stores 1808 may include transaction data 1810 as well as segment storage templates 812.

FIG. 18B depicts a system 1820 that includes a client server architecture. One or more user PCs 1822 accesses one or more servers 824 running an enterprise data management system 1826 on a processing system 1827 via one or more networks 1828. The one or more servers 1824 may access a computer readable memory 1830 as well as one or more data stores 1832. The one or more data stores 1832 may contain transaction data 1834 as well as segment storage templates 1836.

FIG. 18C shows a block diagram of exemplary hardware for a standalone computer architecture 1850, such as the architecture depicted in FIG. 18A that may be used to contain and/or implement the program instructions of system embodiments of the present invention. A bus 1852 may serve as the information highway interconnecting the other illustrated components of the hardware. A processing system 1854 labeled CPU (central processing unit) (e.g., one or more computer processors), may perform calculations and logic operations required to execute a program. A processor-readable storage medium, such as read only memory (ROM) 1856 and random access memory (RAM) 1858, may be in communication with the processing system 1854 and may contain one or more programming instructions for performing the method of implementing and enterprise data management system. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 1860 interfaces one or more optional disk drives to the system bus 1852. These disk drives may be external or internal floppy disk drives such as 862, external or internal CD-ROM, CD-R, CD-RW or DVD drives such as 1864, or external or internal hard drives 1866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1860, the ROM 1856 and/or the RAM 1858. Preferably, the processor 1854 may access each component as required.

A display interface 1868 may permit information from the bus 1856 to be displayed on a display 1870 in audio, graphic, or alphanumeric format. Communication with external devices may optionally occur using various communication ports 1872.

In addition to the standard computer-type components, the hardware may also include data input devices, such as a keyboard 1872, or other input device 1874, such as a microphone, remote control, pointer, mouse and/or joystick.

As additional examples, for example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of providing real-time scoring of received transaction data, comprising:
receiving, using one or more data processors, transaction data describing a particular transaction that has occurred;
storing, using the one or more data processors, the transaction data in an enterprise database, wherein the enterprise database is configured to store transactions of disparate types, wherein the transaction data is stored using a plurality of segments, wherein a segment is formatted according to a template, wherein the template is selected based on an attribute of the transaction, wherein the attribute is a customer attribute, an activity attribute, or a channel attribute;
determining, using the one or more data processors, a transaction type of the particular transaction;
selecting, using the one or more data processors, one or more models from a pool of models based on the determined transaction type, wherein the one or more models are configured based on a plurality of records from the enterprise database; and
generating, using the one or more data processors, a score of the received transaction data based on the transaction data for the particular transaction stored in the plurality of segments and the one or more selected models.

2. The method of claim 1, wherein the one or more models are selected based on the determined transaction type and a transaction model rule, wherein the transaction model rule identifies one or more models to be selected based on transaction type.

3. The method of claim 1, wherein the enterprise database stores information about a customer associated with the particular transaction, information about an activity type of the particular transaction, and a channel associated with the particular transaction.

4. The method of claim 1, wherein the particular transaction is an automated teller machine transaction.

5. The method of claim 4, wherein an authorization model and a fraud model are selected, and wherein an authorization score and a fraud score are generated.

6. The method of claim 5, wherein the fraud score identifies a likelihood of fraud being associated with the particular transaction.

7. The method of claim 1, wherein a model in the pool of models is a fraud model, wherein the fraud model is trained using data associated with prior transactions of disparate types.

8. The method of claim 7, wherein the enterprise database includes information associated with a location of a fraudulent transaction, wherein the location is flagged based on the fraudulent transaction, wherein the particular transaction is associated with the location, and wherein the particular transaction is flagged as being potentially fraudulent based on being associated with the location.

9. The method of claim 1, wherein a model in the pool of models is an authorization model, wherein the score identifies whether the particular transaction should be approved or declined.

10. A computer-implemented system for providing real-time scoring of received transaction data, comprising:
one or more data processors;
one or more computer-readable storage mediums encoded with instructions for commanding the one or more data processors to execute steps that include:
receiving transaction data describing a particular transaction that has occurred;
storing the transaction data in an enterprise database, wherein the enterprise database is configured to store transactions of disparate types, wherein the transaction data is stored using a plurality of segments, wherein a segment is formatted according to a template, wherein the template is selected based on an attribute of the transaction, wherein the attribute is a customer attribute, an activity attribute, or a channel attribute;
determining a transaction type of the particular transaction;
selecting one or more models from a pool of models based on the determined transaction type, wherein the one or more models are configured based on a plurality of records from the enterprise database; and
generating a score of the received transaction data based on the transaction data for the particular transaction stored in the plurality of segments and the one or more selected models.

11. The system of claim 10, wherein the one or more models are selected based on the determined transaction type and a transaction model rule, wherein the transaction model rule identifies one or more models to be selected based on transaction type.

12. The system of claim 10, wherein the enterprise database stores information about a customer associated with the particular transaction, information about an activity type of the particular transaction, and a channel associated with the particular transaction.

13. The system of claim 10, wherein the particular transaction is an automated teller machine transaction.

14. The system of claim 13, wherein an authorization model and a fraud model are selected, and wherein an authorization score and a fraud score are generated.

15. The system of claim 14, wherein the fraud score identifies a likelihood of fraud being associated with the particular transaction.

16. The system of claim 10, wherein a model in the pool of models is a fraud model, wherein the fraud model is trained using data associated with prior transactions of disparate types.

17. The system of claim 16, wherein the enterprise database includes information associated with a location of a fraudulent transaction, wherein the location is flagged based on the fraudulent transaction, wherein the particular transaction is associated with the location, and wherein the particular transaction is flagged as being potentially fraudulent based on being associated with the location.

18. The system of claim 10, wherein a model in the pool of models is an authorization model, wherein the score identifies whether the particular transaction should be approved or declined.

19. One or more computer-readable mediums encoded with instructions for commanding one or more data processors to execute a method of providing real-time scoring of received transaction data, the method comprising:
receiving transaction data describing a particular transaction that has occurred;
storing the transaction data in an enterprise database, wherein the enterprise database is configured to store transactions of disparate types, wherein the transaction data is stored using a plurality of segments, wherein a segment is formatted according to a template, wherein the template is selected based on an attribute of the transaction, wherein the attribute is a customer attribute, an activity attribute, or a channel attribute;
determining a transaction type of the particular transaction;
selecting one or more models from a pool of models based on the determined transaction type, wherein the one or more models are configured based on a plurality of records from the enterprise database; and
generating a score of the received transaction data based on the transaction data for the particular transaction stored in the plurality of segments and the one or more selected models.
